(19) United States
(12) Patent Application Publication
(10) Pub. No.: US 2024/0408714 A1
(43) Pub. Date: Dec. 12, 2024

(54) METHOD OF MONITORING THE CONDITION OF A MACHINE TOOL

(71) Applicant: REISHAUER AG, Wallisellen (CH)

(72) Inventor: Christian DIETZ, Wallisellen (CH)

(73) Assignee: REISHAUER AG, Wallisellen (CH)

(21) Appl. No.: 18/700,052

(22) PCT Filed: Oct. 6, 2022
(86) PCT No.: PCT/EP2022/077837

§ 371 Date: Apr. 10, 2024

(30) Foreign Application Priority Data
Oct. 11, 2021 (CH) 070373/2021

(51) Int. Cl. B23Q 17/00; B23Q 17/09; B23Q 17/12; B23Q 17/20; B23Q 17/22

(52) U.S. Cl. CPC B23Q 17/007; B23Q 17/0961; B23Q 17/12; B23Q 17/20; B23Q 17/22

(57) ABSTRACT

In a method of monitoring a condition of a machine tool (1) with a plurality of machine axes, a test cycle is carried out in which at least some of the machine axes are actuated and associated condition data are determined. Based on this, a condition diagnosis is carried out in which the condition data are compared with reference quantities. The reference quantities are determined from reference condition data obtained in a plurality of reference test cycles on a plurality of reference machines (2, 3, . . . , n).

### TECHNICAL FIELD

The present invention relates to a method of monitoring the condition of a machine tool having a plurality of machine axes. The machine tool may be a gear cutting machine for machining toothed workpieces, in particular a gear grinding machine.

### PRIOR ART

During the machining of workpieces in a machine tool, manufacturing deviations naturally occur, which manifest themselves in deviations of the actually manufactured actual geometry of the workpieces from a specified nominal geometry. The manufacturing deviations can be caused, among other things, by malfunctions or wear of the various components of the machine tool or by unsuitable installation of the components. For example, a manufacturing deviation can be caused by a drive moving a slide of the machine tool to a position other than the nominal position specified by the machine control, by a worn bearing of a spindle, or by machine parts being connected to each other in an unsuitable manner so that vibrations are not sufficiently damped.

It is therefore desirable to detect malfunctions and wear of the machine components, installation errors and other errors of the machine tool that can lead to manufacturing deviations as early as possible in order to be able to take maintenance measures in time. To this end, it is known that before machining workpieces or during breaks in machining, the machine tool runs through a test cycle in which some or all of the machine axes are systematically moved and related measurements are performed. In the process, for example, position deviations of the respective machine axis from a specified nominal position or vibration data can be recorded. The condition of the machine or individual machine axes is then evaluated on the basis of the measurement results. For this purpose, the measurement results can be compared, for example, with specified tolerance limits. If the tolerance range limited by the tolerance limits is exceeded, this indicates a failure of the corresponding machine axis, and maintenance measures can be initiated.

Setting tolerance limits is a very demanding task that requires a lot of expertise. Setting tolerance limits is an iterative process that is prone to error. Moreover, since signals are usually acquired from a few dozen sensors to more than a hundred sensors, this task can be very time-consuming.

EP3229088A1 discloses a method of monitoring the machine geometry of a gear cutting machine, in which workpieces are measured in a measuring device to determine actual data. The actual data are correlated with specification data to determine the deviation of a geometric setting value of an axis of the machine. The deviations of the geometric setting value are stored for a plurality of workpieces, and a statistical evaluation of the stored deviations is performed to determine a geometric change of the axis of the machine. The statistical evaluation includes a short-term evaluation and a long-term evaluation. These evaluations are correlated to automatically detect process deviations. The method is based on measured values obtained on workpieces machined with the monitored machine.

WO2021048027A1 discloses a method of monitoring a fine machining process in which measured values are recorded during the machining of workpieces. The measured values are normalized, and parameters of the machining process are calculated from the normalized values, which correlate in a known manner with machining errors of the workpieces. In this way, process deviations can be detected. The document does not make any statements about monitoring the condition of machine components.

### SUMMARY OF THE INVENTION

In a first aspect, it is an object of the present invention to provide a method of monitoring the condition of a machine tool in which the evaluation of the condition of the machine tool is performed in an objective manner that does not require special expertise.

This object is achieved by a method according to claim 1. Further embodiments are laid down in the dependent claims.

Thus, a method of monitoring a condition of a machine tool having a plurality of machine axes is provided, comprising the following steps:
carrying out a test cycle in which at least a portion of the machine axes are systematically actuated and associated condition data are determined by measurements; and
carrying out a condition diagnosis in which the condition data are compared with at least one reference quantity.

The method is characterized in that the at least one reference quantity is determined from reference condition data, wherein the reference condition data have been obtained in a plurality of reference test cycles on a plurality of reference machines.

In the proposed method, therefore, condition data are available in the form of measurement data or quantities derived therefrom that represent a large number of conditions of a large number of machines. These machines are referred to here as “reference machines”, and the corresponding condition data are referred to as “reference condition data”. The reference condition data may be stored in a database. The reference condition data have been obtained by performing a plurality of test cycles on the reference machines, in particular during machining pauses of the reference machines. These test cycles are referred to as “reference test cycles”. The terms “reference machine”, “reference test cycle” and “reference condition data” are not intended to suggest that a reference machine is a particularly reliable machine, that the reference test cycles are particularly carefully executed test cycles or that the reference condition data are particularly reliable. Rather, these terms are only used to logically distinguish the machine to be evaluated from the machines whose conditions are used as a basis for comparison. The reference condition data may well include condition data obtained on the machine to be evaluated in earlier test cycles. In this respect, the machine to be evaluated can also serve as one of the reference machines. It is essential, however, that the reference condition data are not limited to condition data obtained exclusively with the machine to be evaluated itself. Rather, an essential aspect of the present invention is to make condition data from a plurality of machines usable for evaluating another machine.

This is based on the assumption that in practice the vast majority of the reference test cycles were performed during machining pauses of the reference machines while the corresponding reference machines were in a “good” condition, i.e. in a condition in which the reference machines were capable of producing faultless workpieces. Only a few test cycles will concern “bad” conditions in practice, since such “bad” conditions are usually soon detected on the basis of manufacturing deviations and are eliminated. Therefore, in a statistical average over many reference machines and many reference test cycles, the reference condition data essentially represent a “good” condition of the reference machines. This knowledge is exploited to perform an automatic condition diagnosis of the machine to be evaluated. No prior knowledge of the machine to be evaluated itself is required for this.

It is not sufficient to consider only historical condition data from previous test cycles of the machine to be evaluated itself. For example, the machine to be evaluated may have had a defective bearing installed from the beginning, so that the condition data obtained on this machine over the entire service life of the machine are significantly worse than if a perfect bearing had been installed. Nevertheless, it may be just possible to produce acceptable workpieces despite the faulty bearing. Only by comparing the condition data of the machine to be evaluated with reference condition data obtained by measurements on other machines, or with reference quantities derived from them, is it possible to recognize that the machine to be evaluated has a problem, and to isolate this problem in such a way that the faulty bearing can be detected.

The reference machines are preferably similar to the machine tool to be evaluated. The reference machines do not have to be identical to the machine to be evaluated. In the present context, a machine is considered to be “similar” to the machine to be evaluated if it is largely identical in size, design and axis arrangement. In practice, for example, machines of the same type from the same manufacturer are considered to be similar. However, the machines may differ, for example, in their additional equipment.

The reference condition data may be obtained in particular by performing test cycles with the reference machines, which test cycles are of the same type as for the machine to be evaluated, i.e. test cycles in which machine axes of the reference machines are systematically moved and reference measurements are performed. Also, the condition data determined in the test cycles of the machine to be evaluated may themselves be stored again in the database so that they can in turn serve as reference condition data for future test cycles of the same machine or of another machine.

The measurement data determined in a test cycle may include position deviation data characterizing position deviations of at least part of the movable components from a nominal position specified by the machine control, and/or vibration data characterizing a vibration state of at least part of the movable components. Position deviation data may be obtained with position sensors, such as are sufficiently known from the prior art. Vibration data may be determined using motion sensors, such as accelerometers, also sufficiently known in the prior art. Measurement data may also include power data characterizing a current consumption in a drive motor of at least one moving component. A variety of other types of data are conceivable. Such data may be obtained by separate sensors or may be read directly from the machine control.

The condition data derived from the measured quantities may comprise data of various types. For example, the condition data may comprise direct measurement data, such as individual position deviations or instantaneous vibration amplitudes. However, the condition data may also comprise quantities formed from measurement data by mathematical or algorithmic processing. Such condition data may be, for example, mean values of measurement data, other statistical quantities derived from measurement data, or quantities derived from such statistical quantities. The calculation of condition data from measurement data may comprise a spectral analysis (in particular an order analysis) of measurement data, in particular of position deviation data, vibration data and/or power data. Spectral analysis is used to determine spectral intensity values of the measurement data over a specified frequency or order range, and the condition data may include spectral intensity values at selected discrete frequency values or orders, or quantities derived therefrom, e.g., a sum of such intensity values over a specified frequency or order range, or the results of a peak fitting routine applied to the spectrum. The condition data may also include complete time series of a measured quantity and/or complete spectra.

The condition data may include specific indicators derived from measurement data from more than one source (in particular from more than one sensor) and/or from measurement data relating to the actuation of more than one machine axis. Such specific indicators can allow conclusions to be drawn about very specific sources of error.

If the machine tool is a gear cutting machine, in particular a generating gear cutting machine, the condition data may also include predicted EOL data indicating at which orders excitations are to be expected in an EOL-spectrum on an EOL test bench (EOL=end-of-line) when a geared workpiece machined with the gear cutting machine is installed in a gear assembly and carries out a rolling movement with a mating gear in the gear assembly. The proposed method then allows automatic prediction of the orders at which noise problems are to be expected with workpieces manufactured with the machine being evaluated. With respect to the considerations underlying this procedure and further embodiments, reference is made to the patent application of the same applicant filed on the same date as the present application and entitled “Method of Monitoring the Condition of a Gear Cutting Machine,” the contents of which are incorporated by reference in their entirety in the present disclosure.

The reference quantities may also be quantities of various kinds. Generally speaking, the reference quantities may directly be reference condition data determined in the same way as the condition data discussed above, or they may be quantities formed from reference condition data by mathematical or algorithmic processing, in particular by statistical analysis of the reference condition data.

The reference quantities may in particular comprise at least one tolerance limit for at least one type of condition data. In this case, the tolerance limit is set automatically by a computer on the basis of at least one statistical reference value, which is determined by a statistical analysis of reference condition data of the type in question. In this way, the tolerance limits no longer need to be laboriously set manually, and no expertise is required to set the tolerance limits.

The tolerance limits of the machine to be evaluated are thus determined here by a statistical analysis of reference condition data. The knowledge about the statistical distribution of the reference condition data during a large number of previous test cycles on a large number of similar machines is used to automatically define the tolerance limits of the machine to be evaluated. This is based on the assumption that the reference condition data not only characterize a “good” condition on average, but also fluctuate statistically in a way that is typical for the component or type of machine under consideration, so that fluctuations with similar statistical properties can also be expected on the machine to be evaluated.

In particular, an expectation value of reference condition data and an indicator for a variance (or, equivalently, a standard deviation) of the reference condition data concerned may be calculated as statistical reference values. The tolerance limits of the corresponding condition data of the machine to be monitored may then be set, for example, symmetrically around the expectation value at a distance corresponding to a predetermined multiple of the standard deviation.

The test cycle can be repeated several times at different points in time, with workpieces being machined with the machine tool between the test cycles and the test cycles being performed during machining pauses in which the machining tool is not in a machining engagement with a workpiece. During machining, wear or failure of components of the machine tool can occur, for example. To better detect this, the condition diagnosis can include a comparative evaluation of condition data from several test cycles with the at least one reference quantity.

In particular, the comparative evaluation may include a comparative statistical evaluation that has the following steps:
determining at least one statistical value of the condition data obtained from the plurality of test cycles; and
carrying out a comparison of the statistical value with the at least one reference quantity.

In this way, statistical fluctuations in the condition data from test cycle to test cycle can be made specifically usable for the analysis. For example, a strong fluctuation of a condition data value can indicate a failure of a component even if the mean value of this condition data value shows no abnormalities over several test cycles. In this respect, a measure for the variance of the values of at least one type of condition data from several test cycles can serve as a statistical value.

In advantageous embodiments, a temporal evolution of the condition of the machine as a function of time or the number of processed workpieces is analyzed as part of the condition diagnosis in order to detect imminent failure of machine components in good time. To this end, the evolution of the condition data obtained from the plurality of test cycles may be analyzed as a function of time or of the number of workpieces machined, and the result of this analysis may be compared with the at least one reference quantity. In particular, the analysis of this evolution may include extrapolation of future values of condition data. For the extrapolation, a regression analysis of the condition data may be performed, for example, with a polynomial function, in particular a quadratic function, and a result of the regression analysis may be compared with the at least one reference quantity, for example to predict an expected time of failure of a component. This approach is particularly valuable when the extrapolated condition data are condition data that directly correlate with the quality of a particular component. In this way, imminent failure of a component can be predicted at an early stage and appropriate measures can be taken before failure occurs (“predictive maintenance”).

In some embodiments, for condition diagnosis, the reference condition data stored in the database may be divided into at least two condition classes (e.g., “good” and “bad” or, in a more refined variant, “new condition.” “medium condition,” “critical condition,” and “defective condition”). For each of the condition classes, at least one statistical reference value is then calculated from the reference condition data, and for the condition diagnosis, the condition data are compared with the statistical reference values of the at least two condition classes. In this way, an evaluation parameter can be determined which allows a differentiated evaluation of the condition of the machine or its components.

Depending on a result of the condition diagnosis, an action may be triggered. For example, a diagnostic message may be issued to a user (e.g. a maintenance specialist). The diagnostic message may be transmitted via a network to a terminal device that is spatially separated from the machine tool and may be output there. This may be done, for example, by a messaging service such as SMS or WhatsApp, as a push message or by e-mail. For example, the diagnostic message for selected components and/or for the overall condition of the monitored machine may contain an evaluation parameter that can assume two, three, four or more discrete values, e.g. “good” and “bad” or, in a more differentiated embodiment, “good”, “medium”, “critical” and “defective”. The results of the condition diagnosis may be visualized with the terminal device in a suitable manner. The terminal device may be, for example, a desktop or notebook computer, a tablet computer, or a smartphone. This allows the condition of one or more machines to be monitored from any location.

In addition or alternatively, depending on the result of the condition diagnosis, at least one process parameter may be automatically changed during machining of the workpieces in the machine tool, e.g. a spindle rotational speed, or process recommendations may be automatically issued to a user of the machine tool. In extreme cases, further machining may also be stopped automatically.

Condition diagnosis may include comparative statistical analysis of condition data and reference condition data for at least two different types of condition data to discriminate between the conditions of different components. For example, several types of condition data, such as spectral intensities of vibration signals at different frequencies, may be affected by wear of two components, but in different ways. By performing a comparative statistical analysis of condition data and reference condition data for these two types of condition data, conclusions can be drawn about the component whose wear condition is responsible for the determined condition indicators.

As already mentioned, the reference condition data are preferably stored in a database. The database may be located remotely from the machine being monitored. It may also be implemented in the cloud, e.g., in the form of computing resources shared by multiple users as a service. An evaluation computer may access the database to perform the condition analysis. The evaluation computer is also preferably spatially separated from the machine tool. It is connected to the machine tool by a network connection. The evaluation computer also need not be a single physical entity, but may be implemented in the cloud. The terminal device communicates with the evaluation computer via a network, in particular via the Internet.

The invention also provides a device for monitoring a condition of a machine tool having a plurality of machine axes, the device being configured to perform the foregoing methods. The device comprises a processor and a storage medium on which is stored a computer program which, when executed on the processor, causes the following steps to be performed:
receiving condition data determined in a test cycle of the machine tool, wherein in the test cycle at least part of the machine axes were actuated, wherein associated measurements were made, and wherein the condition data were determined by the measurements; and
performing a condition diagnosis in which the condition data are compared with at least one reference quantity,
wherein the at least one reference quantity is determined from reference condition data, the reference condition data having been obtained in a plurality of reference test cycles on a plurality of reference machines.

The above explanations concerning the methods according to the invention also apply mutatis mutandis to the device according to the invention.

The invention further provides a corresponding computer program. The computer program may be stored on a non-volatile storage medium.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a schematic view of a generating grinding machine;

FIG. 2 shows a diagram illustrating an analysis of measurement data;

FIG. 3 shows a sketch of a network with several similar generating grinding machines communicating with a database via a service server,

FIG. 4 shows a diagram illustrating a statistical distribution of values of a reference condition indicator;

FIG. 5 shows a diagram illustrating a condition diagnosis according to a first example;

FIG. 6 shows a diagram illustrating a condition diagnosis according to a second example; and

FIG. 7 shows a flowchart of a method of monitoring a generating grinding machine.

### DESCRIPTION OF PREFERRED EMBODIMENTS

### Exemplary Structure of a Generating Grinding Machine

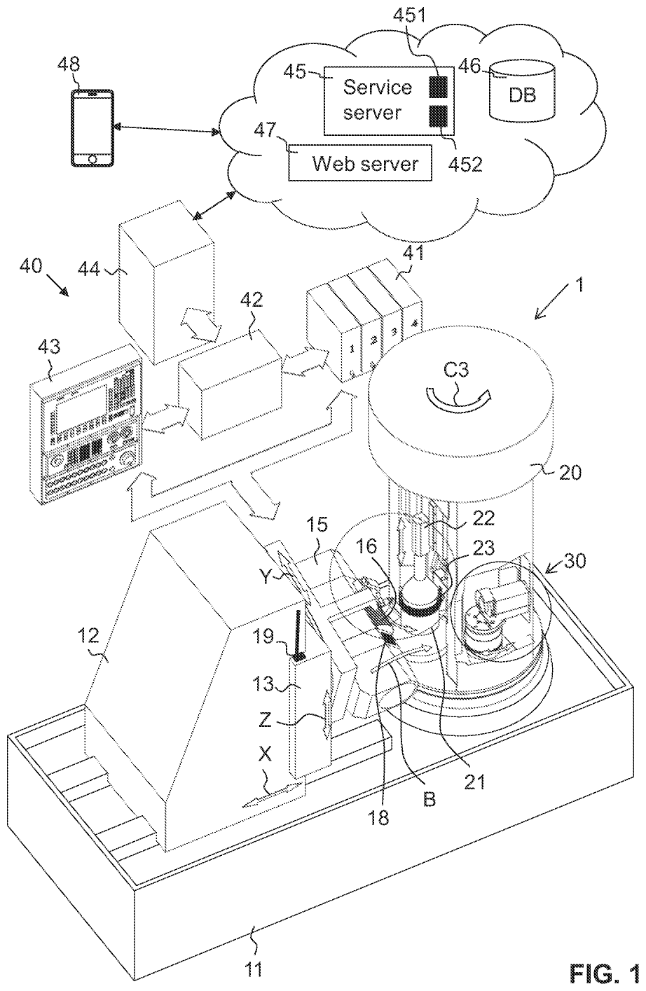

FIG. 1 shows an example of a machine tool in the form of a generating gear grinding machine 1, which is also referred to in the following as “machine” for short. The machine 1 has a machine bed 11 on which a tool carrier 12 is displaceably guided along a radial infeed direction X. The tool carrier 12 carries an axial slide 13, which is guided displaceably along a feed direction Z relative to the tool carrier 12. A grinding head 14 is mounted on the axial slide 13, which can be swiveled about a swivel axis running parallel to the X direction (the so-called A axis) to adapt to the helix angle of the gearing to be machined. The grinding head 14 in turn carries a shift slide on which a tool spindle 15 can be shifted along a shift direction Y relative to the grinding head 14. A worm-shaped profiled grinding wheel (grinding worm) 16 is clamped on the tool spindle 15. The grinding worm 16 is driven by the tool spindle 15 to rotate about a tool axis B.

The machine bed 11 also carries a swiveling workpiece carrier 20 in the form of a turret that can be swiveled between at least three positions about a swivel axis C3. Two identical workpiece spindles are mounted diametrically opposite each other on the workpiece carrier 20, of which only one workpiece spindle 21 with associated tailstock 22 is visible in FIG. 1. A workpiece can be clamped on each of the workpiece spindles and driven to rotate about a workpiece axis C1 or C2. The workpiece spindle 21 visible in FIG. 1 is in a machining position in which a workpiece 23 clamped on it can be machined with the grinding worm 16. The other workpiece spindle, which is offset by 180° and is not visible in FIG. 1, is in a workpiece change position in which a finished workpiece can be removed from this spindle and a new blank can be clamped onto it. A dressing device 30 is mounted offset by 90° to the workpiece spindles.

The machine 1 thus has a large number of movable components such as slides or spindles that can be moved under the control of corresponding drives. These drives are often referred to in the technical world as “NC axes”, “machine axes” or abbreviated as “axes”. In some cases, this designation also includes the components driven by the drives, such as slides or spindles.

The machine 1 also has a large number of sensors. By way of example, only two sensors 18 and 19 are shown schematically in FIG. 1. Sensor 18 is a vibration sensor for detecting vibrations of the housing of grinding spindle 15. Sensor 19 is a position sensor for detecting the position of axial slide 13 relative to tool carrier 12 along the Z direction. In addition, however, the machine 1 comprises a plurality of further sensors. These sensors include, in particular, further position sensors for detecting an actual position of one linear axis in each case, rotation angle sensors for detecting a rotational position of one rotational axis in each case, current sensors for detecting a drive current of one axis in each case, and further vibration sensors for detecting vibrations of one driven component in each case.

All driven axes of the machine 1 are digitally controlled by a machine control 40. The machine control 40 comprises several axis modules 41, a control computer 42 and a control panel 43. The control computer 42 receives operator commands from the control panel 43 as well as sensor signals from various sensors of the machine 1 and calculates control commands for the axis modules 41 from these. It also outputs operating parameters to the control panel 43 for display. The axis modules 41 provide control signals for one machine axis each at their outputs.

A monitoring device 44 is connected to the control computer 42.

The monitoring device 44 may be a separate hardware unit associated with the machine 1. It may be connected to the control computer 42 via an interface known per se, e.g. via the known Profinet standard, or via a network, e.g. via the Internet. It may be spatially part of the machine 1, or it may be spatially remote from the machine 1.

The monitoring device 44 receives a variety of different measurement data from the control computer 42 during operation of the machine. Among the measurement data received from the control computer are sensor data acquired directly by the control computer 42 and data read by the control computer 42 from the axis modules 41, for example, data describing the target positions of the various machine axes and the target current consumption in the axis modules.

The monitoring device 44 may optionally have its own analog and/or digital sensor inputs to directly receive sensor data from further sensors as measurement data. The further sensors are typically sensors that are not directly required for controlling the actual machining process. e.g. acceleration sensors to detect vibrations, or temperature sensors.

The monitoring device 44 can alternatively also be implemented as a software component of the machine control 40, which is executed, for example, on a processor of the control computer 42, or it can be designed as a software component of the service server 45 described in more detail below. In FIG. 1, a processor 451 and a memory device 452 of the service server 45 are indicated accordingly.

The monitoring device 44 communicates directly or via the Internet and a web server 47 with the service server 45. The service server 45, in turn, communicates with a database server 46 with database DB. These servers may be located remotely from the machine 1. The servers need not be a single physical entity. In particular, the servers may be implemented as virtual units in the so-called “cloud”.

The service server 45 communicates with a terminal device 48 via the web server 47. The terminal device 48 can, in particular, execute a web browser with which the received data and their evaluation are visualized. The terminal device does not need to meet any particular computing power requirements. For example, the end device may be a desktop computer, a notebook computer, a tablet computer, a cell phone, etc.

### Machining of a Workpiece Lot

For the sake of completeness, the following describes how workpieces are machined with machine 1.

In order to machine a workpiece that is still to be machined (workpiece blank), the workpiece is clamped by an automatic workpiece changer on the workpiece spindle that is in the workpiece change position. The workpiece change takes place in parallel with the machining of another workpiece on the other workpiece spindle, which is in the machining position. When the new workpiece to be machined is clamped and machining of the other workpiece is completed, the workpiece carrier 20 is swiveled by 180° about the C3 axis so that the spindle with the new workpiece to be machined moves to the machining position. Before and/or during the swiveling process, a meshing operation is performed with the aid of the associated meshing probe. For this purpose, the workpiece spindle 21 is set in rotation, and the position of the tooth gaps of the workpiece 23 is measured with the aid of the meshing probe 24. The roll angle is determined on this basis.

When the workpiece spindle carrying the workpiece 23 to be machined has reached the machining position, the workpiece 23 is brought into collision-free engagement with the grinding worm 16 by moving the tool carrier 12 along the X axis. The workpiece 23 is now machined by the grinding worm 16 in rolling engagement. During machining, the workpiece is continuously advanced along the Z axis at a constant radial X infeed. In addition, the tool spindle 15 is moved slowly and continuously along the shift axis Y in order to continuously use unused areas of the grinding worm 16 for machining (so-called shift movement).

Parallel to the workpiece machining, the finished workpiece is removed from the other workpiece spindle and another blank is clamped on this spindle.

If, after machining a certain number of workpieces, the use of the grinding worm 16 has progressed to such an extent that the grinding worm is too blunt and/or the flank geometry is too inaccurate, then the grinding worm is dressed. For this purpose, the workpiece carrier 20 is swiveled by ±90° so that the dressing device 30 reaches a position in which it is opposite the grinding worm 16. The grinding worm 16 is now dressed with the dressing tool 33.

### Test Cycle

During machining pauses, a test cycle is performed by the monitoring device 44 in interaction with the machine control 42 to check the condition of individual or all components of the machine 1. During such a test cycle, a selected part of the machine axes or all machine axes are systematically actuated and measurements are taken on the machine.

For example, each linearly displaceable component is displaced with the associated machine axis, and the instantaneous position of the component is determined continuously or for selected positions with the aid of the aforementioned position sensors. From this, position deviations between the specification (nominal position) and the measurement (actual position) are determined and transmitted to the monitoring device 44. The same can also be done for the rotationally driven spindles, whereby rotary angle sensors are then used to determine position deviations.

The vibration behavior is also determined for selected components (in particular slides and spindles) while the component in question is driven by the assigned machine axis. Vibration sensors connected to these components are used for this purpose. The results of the vibration measurements are also transmitted to the monitoring device 44.

Furthermore, the power consumption of the drive motors of the machine axes is determined. Current sensors integrated in the axis modules 41 can be used for this purpose, for example. In addition, temperatures of the drive motors and other measured quantities can be determined.

All this can be done while one machine axis is actuated alone. However, it is also possible to actuate two or more machine axes in a coupled manner, so that the behavior of the machine is recorded when two or more machine axes are actuated simultaneously. In this case, for example, amplified vibrations can occur that are greater than would be expected based solely on the vibration behavior when a single machine axis is actuated, or controller errors can be detected that can only be determined when two machine axes are actuated synchronously.

In addition, it is conceivable to specifically cause vibrations and record the response of the various machine components in order to investigate the damping behavior of the machine. From such investigations, conclusions can be drawn about the quality of the joints between the machine components. In particular, automatic frequency response measurements can be performed.

The monitoring device 44 determines various condition data from the received measurement data. The condition data allow direct or indirect conclusions to be drawn about the condition of the machine or its individual components.

The condition data are obtained by selection from the measurement data and/or by mathematical processing and analysis from the measurement data. Some examples of condition data are given below.

### a) Basic Indicators

Certain types of condition data, obtained by selecting or mathematically analyzing signals from a single sensor, which allow conclusions to be drawn about the condition of a single component, are referred to below as basic indicators.

An example of a basic indicator is a position deviation indicator. This can be, for example, a single measured position deviation or an average of several measured position deviations of the same component at different nominal positions. A position deviation indicator gives a direct indication of the positioning accuracy of the component concerned.

Another example is the maximum current consumption of a drive motor during a motion process. This maximum current consumption allows conclusions to be drawn, for example, about excessive friction or jamming of the machine axis concerned.

A third example is a mean amplitude (e.g. RMS value) of the signals of a vibration sensor during a motion process. The mean amplitude allows direct conclusions to be drawn about the tendency of a component to vibrate.

Certain vibration indicators, which are determined from a spectral analysis of vibration signals for a single motion process, can also be referred to as basic indicators. Specifically, the spectral intensities at selected discrete excitation frequencies or excitation orders can be determined. These intensities can serve directly as basic indicators, or basic indicators can be calculated from these intensities by simple mathematical operations, e.g. addition or averaging.

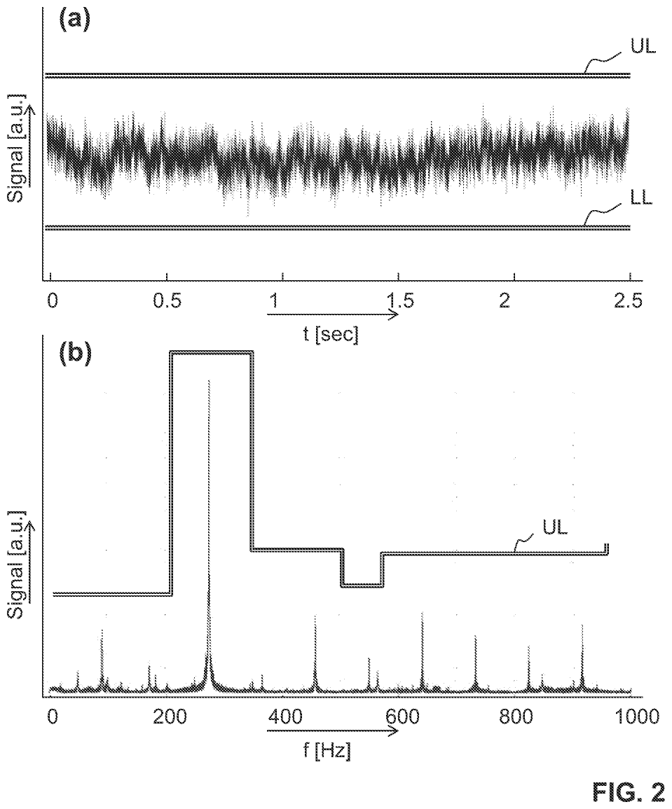

This is exemplarily illustrated in FIG. 2, which exemplarily illustrates a time signal of a vibration sensor connected to the tool spindle and a spectrum that can be obtained from a time signal by a filtering and FFT operation. The monitoring device can calculate an RMS amplitude from the time signal, for example. It may further evaluate the spectrum in the vicinity of a plurality of discrete frequency values to determine intensities of the spectrum at those frequency values. These discrete frequency values may be, for example, certain multiples of the workpiece rotational speed (“orders”). The spectrum of FIG. 2 contains several clearly visible peaks at such frequency values.

For example, strong peaks at the tool rotational speed and its integer multiples (i.e., integer orders) can indicate eccentricity in the tool spindle. Peaks at certain integer or non-integer multiples of the tool rotational speed (integer or non-integer orders) may indicate bearing damage in the tool spindle. If the bearing orders are known, it may be possible to identify the affected bearing from the order of the peak. In some cases, an assignment to individual fault patterns can only be made by means of a differential diagnosis. For example, it is conceivable that only an analysis of the relative intensity ratios of the peaks to one another will allow conclusions to be drawn as to which component of the machine is responsible for the peaks.

In the simplest case, the intensities of the peaks in a certain frequency or order range can simply be added to obtain a global basic indicator for the entire component. Although this does not allow any conclusions to be drawn about individual causes of poor component condition (such as eccentricity or bearing damage), it can be sufficient to detect a malfunction of the component concerned in the first place and to initiate appropriate maintenance measures.

Instead of determining intensities of individual peaks and using them as basic indicators, it is also conceivable to use all values of a complete spectrum as condition quantities.

### b) Specific Indicators

Specific indicators can be condition data resulting from a mathematical or algorithmic combination of measured quantities from different sources (in particular from different sensors) or measured quantities from a single sensor when more than one machine axis is actuated (also e.g. from coupled movements of machine axes). Such condition indicators can allow very specific conclusions to be drawn about the causes of problem conditions, but require specific knowledge about the interaction of the individual components of the machine.

An example of such a specific indicator is a condition quantity that results from a calculation that includes, on the one hand, the average current consumption of a drive motor of a linear axis and, on the other hand, the spectral intensities of an acceleration sensor over a wide frequency range. Such an indicator can e.g. allow to narrow down the cause of increased friction of the linear axis in question (e.g. worn ball screw drive).

Another example of such a specific indicator is a condition quantity determined for a coupled movement of the tool spindle and the shift slide by performing the following calculation:

$${Z}_{SF} = {Δϕ}_{WZ} \cdot {m}_{n} \cdot π \frac{{z}_{0}}{cos γ} - Δ Y$$

Here Δϕ_{WZ} denotes a change in the rotation angle of the grinding worm, mₙ denotes the normal module of the grinding worm, z₀ denotes the number of starts on the grinding worm, y denotes the lead angle of the grinding worm, and ΔY denotes the shifting distance. The change in the rotation angle ΔϕWZ and the shifting distance ΔY are chosen in such a way that the quantity Z_{SF} should become zero. A deviation from zero then indicates a position error (lag error). In this respect Z_{SF} or the maximum of Z_{SF} over a test cycle can be considered as a specific indicator for such a position error.

An overall condition indicator for the total assessment of a component can also be formed from all condition data characterizing the component in question. In this way, the condition of each component is represented by only one indicator. If the one overall condition indicator shows a problem, troubleshooting can then be performed using individual condition quantities.

The correlations that allow the calculation of such specific indicators often only become apparent through the data analysis of very large data sets across many machines (e.g., through correlation analysis of known damage patterns with assigned basic indicators). Specific indicators are often specific to a particular machine type and cannot be easily transferred to other machine types.

### Database

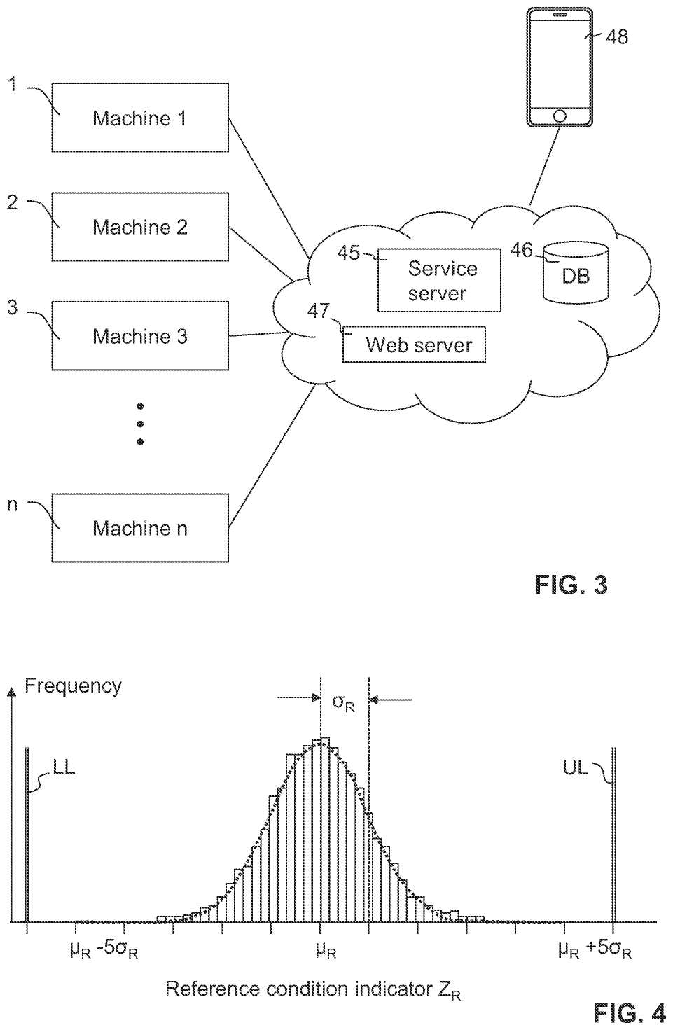

The function of the database DB is now explained with reference to FIG. 3. Via a web server 47, the machine 1 to be monitored and a plurality of similar machines 2, 3, . . . , n are connected to the service server 45 and to the database server 46 with the database DB.

Each of these machines comprises a monitoring device that continuously transmits certain data to the database DB during operation of the respective machine. This data includes in particular a unique identifier of the machine, a time stamp and a plurality of condition data as described above. The data may optionally also include further data, for example data on the workpieces processed subsequently to a test cycle, e.g. indicators of the workpiece quality achieved.

These data are stored in the database DB. As a result, over time the database contains a very large amount of condition data obtained for several similar machines in many different test cycles. These condition indicators are referred to below as reference condition data.

### Evaluation of the Reference Condition Indicators

The reference condition quantities can be evaluated statistically. Such a statistical evaluation can be carried out in particular to gain knowledge about the typical fluctuation behavior of the reference condition quantities and, on this basis, to define tolerance limits for the condition quantities of the machine to be monitored. The change in condition quantities over the life cycle of a machine can also be statistically evaluated, and current condition quantities of a particular machine can be compared with the reference condition quantities stored in the database, for example to automatically obtain indications of component wear.

This will be explained in more detail below using a few examples,

### a) Automated Setting of Tolerance Limits

With reference to FIG. 4, the following is an example of how tolerance limits for condition data of the machine 1 to be monitored can be set with the aid of the data in the database. The corresponding calculations can be performed by the service server 45.

The database contains values of reference condition data for a large number of test cycles in many similar machines. It can be assumed that these values were obtained for the most part for machines that operated without faults, because faults are usually detected and eliminated sooner or later. In this respect, it can be assumed that the values of the reference condition data are statistically distributed essentially as would be expected for a faultless machine, with only a few statistical outliers caused by machines with worn components.

FIG. 4 illustrates an example of a distribution of the values of any type of reference condition data. On the horizontal axis the values of the reference condition data are plotted, on the vertical axis as a bar chart the relative frequency for equal value intervals (“bins”). It can be seen that the distribution of the values of the reference condition data in the present example essentially corresponds to a normal distribution, whose density function is also plotted with a dotted line in FIG. 4. The distribution of FIG. 4 has an expected value μ_{R} and a standard deviation σ_{R} and variance σ_{R}² respectively.

The term “expected value” is used here synonymously with the term “sample mean value”. The term “variance” is used here to denote the mean square deviation of the values of a sample from the sample mean value. “Standard deviation” is the square root of the variance.

The lower and upper tolerance limits LL, UL of the corresponding condition data of the machine to be monitored can now be determined automatically on the basis of this statistical distribution. For this purpose, a fit of a suitable density function (here the density function of the normal distribution) to the distribution of the values of the reference condition data is performed in order to determine the expected value μ_{R} and the standard deviation σ_{R}. In practice, this fit will provide more accurate results the more reference condition data there are in the database. The tolerance range can now be defined symmetrically around the expected value μ_{R} as a range [μ_{R}−p·σ_{R}, μ_{R}+p·σ_{R}], where the factor p is a positive real number indicating by how many standard deviations the tolerance limits are away from the expected value. Following the well-known 6σ-concept (which, however, is usually used for a different purpose), e.g. p=6 can be chosen. If the customer's requirements are less sensitive to tolerances, a larger factor of p can be chosen.

At each future test cycle, the service server 45 now compares the relevant condition data with the tolerance limits LL, UL. In FIG. 2, such tolerance limits are schematically drawn for some types of condition data. When the value of the condition data leaves the tolerance range, the service server 45 triggers an appropriate action. For example, the service server 45 may send an SMS, a push message, or an email to a maintenance specialist. Optionally, the service server can also influence future machining operations or even temporarily stop machining on machine 1.

### b) Definition of Condition Classes

In order to be able to carry out a more differentiated assessment of the condition of components, it is conceivable to divide the values of reference condition data into two, three, four or more condition classes. This can be done purely on the basis of the values themselves or on the basis of further information. For example, an analysis of the reference condition data can show that there are always points in time when a reference condition quantity suddenly assumes a “better” value. It can then be concluded that this abrupt improvement is the result of maintenance or replacement of a component.

Such events can be easily identified in the totality of the reference condition data, and values of the reference condition data for a certain number of test cycles immediately after such an event can be sorted into a class A, denoting the new condition. Values of the reference condition data for a certain number of test cycles immediately before such an event, on the other hand, can be sorted into a class C denoting a critical condition. Values of the reference condition data between classes A and C can be sorted into a class B, denoting an average usage condition, and outliers of the condition data that are “worse” than the class C values can be sorted into a class D, denoting a defective condition.

Classification into the various condition classes can also be based on criteria other than sudden changes in the values of reference condition data. For example, it is conceivable that information about the number of machining operations that have already been performed with a component, about the number of operating hours of the component in question, or about the quality of the workpieces produced with the machine after an inspection cycle has been stored directly in the database. The classification into condition classes can then be made taking this information into account. A corresponding classification can be made, for example, with the aid of a machine learning algorithm (ML algorithm).

The values of the reference condition data can now be statistically analyzed separately for each of the condition classes. For example, an expected value and a variance can be determined separately for each condition class.

The current value of a condition quantity can now be compared, for example, with the expected values of the corresponding reference condition quantity for the various condition classes in order to draw conclusions about the wear condition of a component.

c) Consideration of Condition Data from Several Test Cycles: Extrapolation and Statistical analysis

By considering the values of condition data from different test cycles, it is possible to characterize the condition of a component even better than is possible by considering a single value.

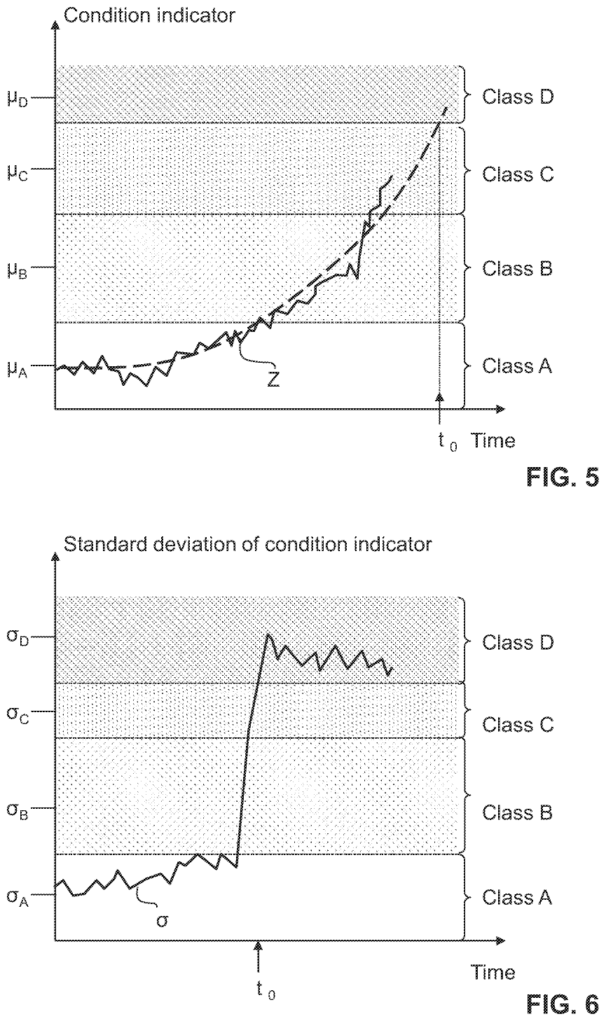

FIG. 5 illustrates an example of the value of a condition quantity Z as a function of time or as a function of successive test cycles. The value of Z changes from test cycle to test cycle. Initially it fluctuates around a value μ_{A} around. This value is the expected value of the corresponding reference condition quantity for the condition class A. Thus, it can be concluded that the component whose condition is characterized by the condition quantity Z is initially quasi in a new condition. With time, however, the instantaneous value of Z increases and initially reaches a value of μ_{B}, which is the expected value of the corresponding reference condition quantity for condition class B, and then a value of μ_{C}, which is the expected value of the corresponding reference condition quantity for the condition class C. Accordingly, it can be concluded that the component in question has changed over an average usage condition to a critical condition. To predict the time of failure of the component, an extrapolation of the value of Z can be made for the future. This can be done, for example, by a regression analysis. In FIG. 5, a quadratic regression curve is drawn as a dashed curve as an example. The predicted failure time t₀ can then be assumed to be the point in time at which this curve reaches a typical range of values for condition class D, for example. This type of analysis enables predictive maintenance of the component before it fails (“Predictive Maintenance”).

It is also conceivable to determine values of a condition quantity over several test cycles and to perform a statistical analysis for the totality of the values collected in this way in order to compare the distribution of these values with the distribution of values of the reference condition quantity.

In the simplest case, an instantaneous expected value of the condition quantity can simply be determined from the collected values and compared with the expected value of the reference condition quantity. The “instantaneous expected value” is the expected value over a certain number of test cycles.

Instead of comparing expected values, other statistical parameters can be compared. For example, for each of the condition classes, the corresponding variance or standard deviation of the values of the reference condition quantity can be determined. Often, as a component wears, not only does the expected value of a corresponding condition quantity change, but its variance also increases. Accordingly, monitoring the variance or standard deviation also allows conclusions to be drawn about the wear condition of a component.

This is exemplarily illustrated in FIG. 6. In FIG. 6 the temporal course of the instantaneous standard deviation a of a condition quantity is plotted. It can be seen that the standard deviation around a point in time t₀ suddenly increases strongly and almost corresponds to the standard deviation of the reference condition quantities in condition class D. This indicates a sudden failure of the corresponding component.

In the present case, monitoring of the statistical parameter “standard deviation” or “variance” can provide an indication of a component failure even if the expected value of the corresponding condition quantity has not changed at all. In this respect, statistical analysis allows the imminent or actual failure of a component to be detected much more reliably than if only individual values were monitored.

Instead of a simple statistical analysis of the kind described above, a classification algorithm can also be used, for example, which correlates a certain set of condition quantities with reference condition quantities in order to draw conclusions about the condition of a component. Again, an ML algorithm can be used for this purpose.

### d) Output of the Results and Visualization

The results of automatic component diagnostics can be easily visualized, e.g. with a traffic light system in which the condition of each component is individually evaluated as green (good), yellow (caution required) or red (bad). Depending on the condition of the components, an assessment of the condition of the entire machine can be made in the same way. This provides a very simple overview of the condition of the machine and its components. Indications of imminent failure can also be output in the sense of “predictive maintenance”.

By clicking on one of the components, the associated data that led to the corresponding assessment can be visualized in a simple way.

The visualization can be carried out platform-independently on any end device via a web browser. Other evaluation measures can also be implemented in a correspondingly platform-independent manner. This facilitates analysis even remotely. In particular, the condition of any machine can be checked in detail from any mobile device via the cloud.

In addition, it is conceivable to send a corresponding message automatically via SMS, push message or e-mail when conditions exist that require intervention, as has already been explained above.

### Flowchart

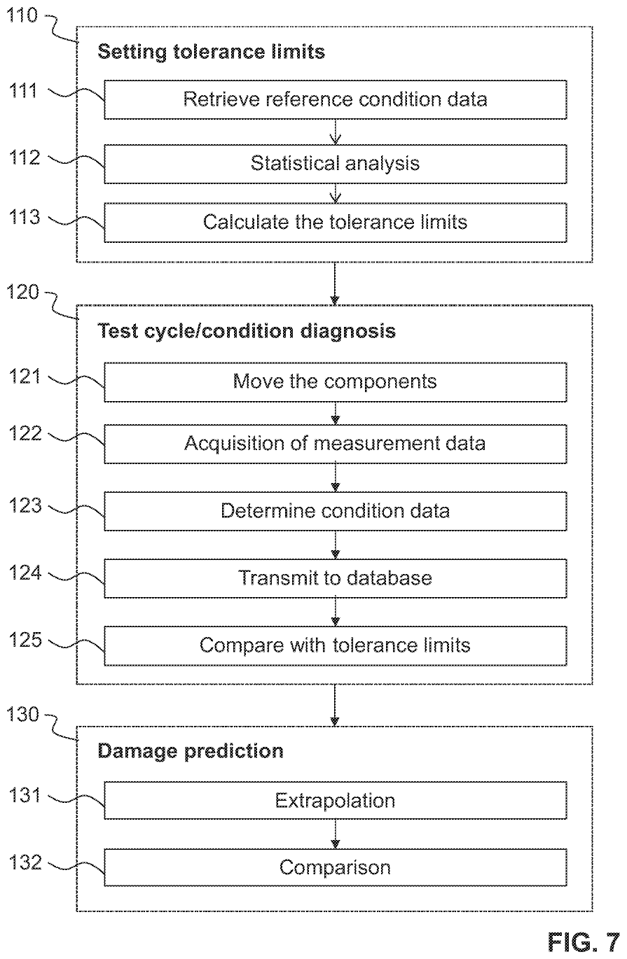

FIG. 7 shows an exemplary flow chart summarizing a method of monitoring the condition of a generating grinding machine.

In block 110, tolerance limits are first defined for condition quantities. For this purpose, reference condition quantities for comparable machining situations are retrieved from the database in step 111 and statistically analyzed in step 112. Based on this statistical analysis, the tolerance limits are set in step 113.

In block 120, a test cycle is then performed with subsequent condition diagnosis using these tolerance limits. The components of the machine are moved (step 121), and during this process measurement data are continuously acquired (step 122). Condition quantities are formed from the measurement data (step 123) and transmitted to the database for storage (step 124). In step 125, the condition quantities are compared with the tolerance limits, and actions are triggered based on the comparison, e.g. a graphical output of the condition evaluation of the components.

In block 130, the future failure of machine components is predicted. For this purpose, the current condition quantities are extrapolated into the future (step 131). In step 132, the extrapolation result is compared with statistical values of the reference condition quantities or with the tolerance limits, and actions are triggered based on the comparison, e.g. an output of the predicted time of failure.

1. A method of monitoring a condition of a machine tool having a plurality of machine axes, comprising the following steps:
carrying out a test cycle in which at least a portion of the machine axes are actuated and associated condition data are determined by measurements; and
carrying out a condition diagnosis in which the condition data are compared with at least one reference quantity,
wherein the at least one reference quantity is determined from reference condition data, wherein the reference condition data have been obtained in a plurality of reference test cycles on a plurality of reference machines.

2. The method according to claim 1,
wherein the at least one reference quantity comprises a tolerance limit for at least one type of condition data,
wherein the tolerance limit is set in an automated manner on the basis of at least one statistical reference value,
wherein the statistical reference value is determined by a statistical analysis of the reference condition data.

3. The method according to claim 2, wherein the at least one statistical reference value comprises an expectation value of at least one type of reference condition data and an indicator for a variance of the respective type of reference condition data.

4. The method according to claim 1,
wherein the test cycle is repeated several times at different points in time, wherein workpieces are machined with the machine tool between the test cycles,
wherein the condition diagnosis comprises a comparative evaluation comparing condition data obtained in several test cycles with the at least one reference quantity.

5. The method according to claim 4, wherein the comparative evaluation comprises:
determining at least one statistical value of the condition data obtained from the plurality of test cycles; and
carrying out a comparison of the statistical value with the at least one reference quantity.

6. The method according to claim 4, wherein the comparative evaluation comprises:
analyzing an evolution of the condition data obtained from the plurality of test cycles as a function of time or a number of workpieces machined with the machine tool; and
comparing a result of this analysis with the at least one reference quantity.

7. The method according to claim 1,
wherein at least two condition classes are formed from the reference condition data,
wherein for each condition class at least one statistical reference value is calculated, and
wherein, in the condition diagnosis, the condition data are compared with the statistical reference values of the condition classes.

8. The method according to claim 1, comprising:
triggering an action depending on a result of the condition diagnosis.

9. The method according to claim 8,
wherein the action comprises issuing a diagnostic message to a user.

10. The method according to claim 8, comprising:
automatically changing at least one process parameter for machining workpieces in the machine tool as a function of the result of the condition diagnosis.

11. The method according to claim 1, wherein the condition data comprise the following types of data and/or comprise data derived from the following types of data:
position deviation data that are indicative of position deviations of at least one of the components from a nominal position, wherein the position deviation data are determined with at least one position sensor,
vibration data that are indicative of a vibration state of at least one of the components, the vibration data being determined with at least one motion sensor; and/or
power data that are indicative of a current consumption in a drive motor of at least one of the components.

12. The method according to claim 1,
wherein the determination of the condition data comprises a spectral analysis of measurement data.

13. The method according to claim 1,
wherein the condition data comprise at least one specific condition indicator derived from measurement data from more than one source or from measurement data relating to the actuation of more than one machine axis.

14. The method according to claim 1,
wherein the condition data comprise predicted EOL data indicating at which orders excitations are to be expected in an EOL spectrum on an EOL test bench when a toothed workpiece machined with the gear cutting machine is installed in a gear assembly and carries out a rolling motion with a mating gear in the gear assembly.

15. The method according to claim 1,
where the reference condition data are stored in a database.

16. The method according to claim 15,
wherein an evaluation computer accesses the database for performing the condition analysis, and
wherein the evaluation computer is arranged spatially separate from the machine tool and is connected to the machine tool by a network connection.

17. The method according to claim 15,
comprising storing the condition data in the database so that they are available for future test cycles as reference condition data.

18. A device for monitoring a condition of a machine tool having a plurality of machine axes, comprising a processor and a storage medium on which is stored a computer program which, when executed on the processor, causes the following steps to be carried out:
receiving condition data determined in a test cycle of the machine tool, wherein in the test cycle at least a portion of the machine axes was actuated, wherein associated measurements were made, and wherein the condition data were determined by the measurements; and
carrying out a condition diagnosis in which the condition data are compared with at least one reference quantity,
wherein the at least one reference quantity is determined from reference condition data, wherein the reference condition data have been obtained in a plurality of reference test cycles on a plurality of reference machines.

19. The method according to claim 6, wherein analyzing the evolution of the condition data comprises extrapolating future values of the condition indicator.

20. The method according to claim 9, wherein the diagnostic message is transmitted via a network to a terminal device, which is spatially separated from the machine tool, and outputted by the terminal device.

21. The method according to claim 12, wherein the spectral analysis determines spectral intensity values for discrete excitation frequencies or excitation orders, and wherein the condition data comprise said spectral intensity values or quantities derived therefrom.
